(19) United States
(12) Patent Application Publication
(10) Pub. No.: US 2014/0010303 A1
(43) Pub. Date: Jan. 9, 2014

(54) MOTION COMPENSATION IMAGE PROCESSING METHOD AND ASSOCIATED APPARATUS

(71) Applicant: MSTAR SEMICONDUCTOR, INC., Hsinchu Hsien (TW)

(72) Inventors: Wei-Hsiang Hong, Hsinchu Hsien (TW); Yu-Hsiang Tseng, Hsinchu Hsien (TW); Tai-Hsun Hu, Hsinchu Hsien (TW); Chia-Chiang Ho, Hsinchu Hsien (TW)

(73) Assignee: MSTAR SEMICONDUCTOR, INC., Hsinchu Hsien (TW)

(21) Appl. No.: 13/789,928

(22) Filed: Mar. 8, 2013

(30) Foreign Application Priority Data
Jul. 3, 2012 (TW) 101123923

(51) Int. Cl. H04N 7/26

(52) U.S. Cl. CPC H04N 19/00587
USPC 375/240.16

(57) ABSTRACT

A motion compensation image processing apparatus includes an external memory, a cache, a motion compensation module, a determination module and a fetching module. The external memory stores a reference frame associated with an image block. The motion compensation module sequentially performs motion compensation on a previous image block and the image block. When the motion compensation module performs motion compensation on the previous image block, the determination module determines a motion vector relative to the reference frame. Before the motion compensation module performs motion compensation on the image block, the fetching module fetches a reference region, corresponding to the motion block, in the reference frame from the external memory to the cache.

This application claims the benefit of Taiwan application Serial No. 101123923, filed Jul. 3, 2012, the subject matter of which is incorporated herein by reference.

### BACKGROUND OF THE INVENTION

1. Field of the Invention

The invention relates in general to an image processing technique, and more particularly, to a technique for managing/utilizing a memory in an image processing system.

2. Description of the Related Art

Motion compensation is a prevalent mechanism applied in the field of dynamic image compression. For example, in block motion compensation adopted in moving picture experts group (MPEG) specifications, a frame to be encoded is divided into multiple blocks in a size of 16 by 16 pixels. For each of the blocks, an encoder finds a most similar region in a reference frame as a reference region, and determines a motion vector between a block and a corresponding reference region. Apart from the motion vector, the encoder further determines an image content difference between the block and the corresponding reference region. The image content difference is referred to as a residual. After eliminating an influence of the motion vector, the residual of a block becomes smaller as the block appears to be more similar to a reference region. In an encoded result, each block is expressed by a motion vector and a residual.

FIG. 1A shows an exemplary operating timing diagram of motion compensation performed by a conventional encoder. The encoder first determines a reference region in a reference frame, which is most similar to a block A in a frame to be encoded. The reference frame to be compared with the frame to be encoded is generally stored in an external memory of the encoder. Within a time interval T1, assume that the encoder determines that the reference region most similar to the block A in the frame to be encoded is distributed in blocks R1 and R2 in the reference frame. When generating the residual corresponding to the block A, the encoder needs to fetch image data of the blocks R1 and R2 from the external memory. A time interval T2 specifies the time the encoder waits for a response from the external memory after sending out a request of fetching the block R1. A time interval T3 specifies the time needed for sending the block R1 from the external memory to the encoder. A time interval T4 specifies the response time of the external memory after the encoder sends out a request of fetching the block R2. A time interval T5 specifies the time needed for sending the block R2 from the external memory to the encoder. A time interval T6 specifies the time for the encoder to generate the residual corresponding to block A according to the blocks R1 and R2. Accordingly, six time intervals T1 to T6 are consumed for the encoder to generate the residual for each of the blocks in the frame to be encoded.

FIG. 1B shows an exemplary operating timing diagram of motion compensation performed by a conventional decoder. Similarly, a reference frame to be compared with the frame to be decoded is generally stored in an external memory of the decoder. To reconstruct the foregoing block A, in a time interval T1′, according to a motion vector in a decoded result, the decoder first determines that a reference region for generating the motion vector is distributed in the blocks R1 and R2 in the reference frame. Thus, the decoder needs to fetch image data of the blocks R1 and R2 from the external memory. A time interval T2′ specifies the time the decoder waits for a response from the external memory after sending out a request of fetching the block R1. A time interval T3′ specifies the time needed for sending the block R1 from the external memory to the decoder. A time interval T4′ specifies the time the decoder waits for a response from the external memory after sending out a request of fetching the block R2. A time interval T5′ specifies the time needed for sending the block R2 from the external memory to the decoder. A time interval T6′ specifies the time that the decoder needs to reconstruct block A according to the blocks R1 and R2 as well as the residual. Accordingly, six time intervals T1′ to T6′ are consumed for the decoder to reconstruct each of the blocks in the frame to be decoded.

Increasing frame size and resolution continue to be development trends in image systems, inferring that both the encoder and the decoder are expected to operate with greater computing efficiency. It is seen from the above descriptions that, the computing efficiency of the encoder and the decoder worsens as a total duration of the time intervals T1 to T6 and T1′ to T6′ gets longer.

### SUMMARY OF THE INVENTION

To overcome the above issue, the invention is directed to a motion compensation image processing apparatus and associated method. While performing motion compensation on an image block, reference data needed for a next image block is in advance fetched from an external memory to a cache to achieve time saving. Moreover, as data already stored in the cache is not repetitively fetched, the image processing apparatus and associated method of the present invention further enhances processing efficiency.

According to an embodiment the present invention, a motion compensation image processing apparatus is provided. The apparatus includes an external memory, a cache, a motion compensation module, a determination module and a fetching module. The external memory stores a reference frame associated with an image block. The motion compensation module sequentially performs motion compensation on a previous image block and the image block. When the motion compensation module performs motion compensation on the previous image block, the determination module determines a motion vector of the image block relative to the reference frame. Before the motion compensation module performs motion compensation on the image block, the fetching module fetches a reference region, corresponding to the motion vector, in the reference frame from the external memory to the cache.

According to another embodiment of the present invention, a motion compensation image processing method cooperating with an external memory and a cache is provided. The external memory stores a reference frame associated with an image block. The method includes steps of: performing motion compensation on a previous image block; before the step of performing motion compensation on the previous image block ends, determining a motion vector of the image block relative to the reference frame; fetching a reference region, corresponding to the motion vector, in the reference frame from the external memory to the cache; and performing motion compensation on the image block.

According to another embodiment of the present invention, a motion compensation image processing apparatus is provided. The apparatus includes an external memory, a cache, a motion compensation module, a determination module and a fetching module. The external memory stores a reference frame associated with an image block. The motion compensation module performs motion compensation on the image block. The determination module determines a motion vector of the image block relative to the reference frame. The fetching module fetches a remaining region of a reference region corresponding to the motion vector that is not stored in the cache from the external memory to the cache.

According to yet another embodiment of the present invention, a motion compensation image processing method cooperating with an external memory and a cache is provided. The external memory stores a reference frame associated with an image block. The method includes steps of: determining a motion vector of the image block relative to the reference frame; fetching a remaining region of a reference region corresponding to the motion vector that is not stored in the cache from the external memory to the cache; and performing motion compensation on the image block according to the reference region stored in the cache.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1A is an exemplary operating timing diagram of motion compensation preformed by a conventional encoder; FIG. 1B is an exemplary operating timing diagram of motion compensation preformed by a conventional decoder.

FIG. 2 is a block diagram of an encoder according to an embodiment of the present invention.

FIG. 3 is an operating timing diagram of an encoder according to an embodiment of the present invention.

FIG. 4 is an example of relations between a reference frame and reference regions.

FIG. 5A and FIG. 5B are block diagrams of a decoder according to an embodiment of the present invention.

FIG. 6 is a block diagram of an image processing apparatus according to an embodiment of the present invention.

FIG. 7 and FIG. 8 are flowcharts of an image processing method according to embodiments of the present invention.

### DETAILED DESCRIPTION OF THE INVENTION

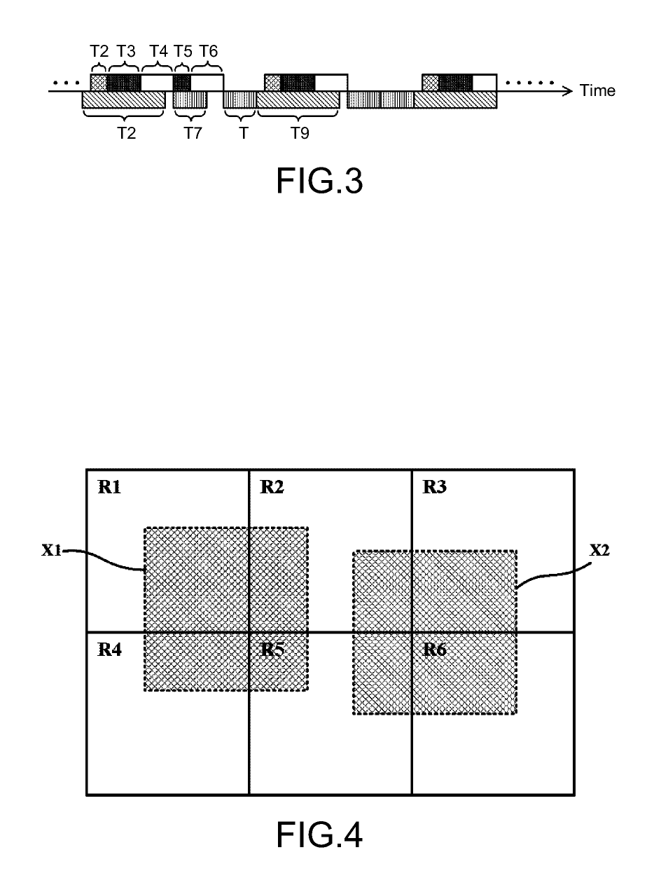

FIG. 2 shows an encoder 200 according to an embodiment of the present invention. The encoder 200 includes an external memory 21, a cache 22, a motion compensation module 23, a determination module 24 and a fetching module 25. In practice, the encoder 200 may be integrated to various image processing systems or image playback apparatuses, or may be an independent unit. As such, encoder 200 may be implemented in hardware, software or a combination thereof. For example, encoder 200 may be implemented as an application specific integrated circuit (ASIC) encoded with logic (or instructions) configured to perform the functionality described herein.

The external memory 21 stores a reference frame associated with an image block that is to be processed or is being processed by the motion compensation module 23. More specifically, the reference frame is a comparison basis of blocks of a frame to be encoded for generating a motion vector and a residual. The cache 22 buffers a small amount of data that the motion compensation module 23 needs within a short period of time. In practice, the external memory 21 may be implemented by a dynamic random access memory (DRAM), and the cache 22 may be implemented by a static random access memory (SDRAM). Compared to the external memory 21, the cache 22 may have a higher hardware cost but a faster access speed.

As shown in FIG. 2, a bitstream of the frame to be encoded is respectively provided to the motion compensation module 23 and the determination module 24, so that the motion compensation module 23 and the determination module 24 may respectively perform image processing on different blocks at the same time. More specifically, assume that the motion compensation module 23 sequentially performs motion compensation on two image blocks B1 and B2 (not shown) in the frame to be encoded to respectively generate the residuals and the motion vectors corresponding to the image blocks B1 and B2 as encoded data of the image blocks B1 and B2. When the motion compensation module 23 performs motion compensation on the image block B1, the determination module 24 determines the motion vector of the image block B2 relative to the reference frame. After the determination module 24 generates the motion vector of the image block B2, the fetching module 25 fetches a reference region, corresponding to the motion vector, in the reference frame from the external memory 21 to the cache 22 so that the motion compensation module 23 can perform motion compensation encoding on the image block B2.

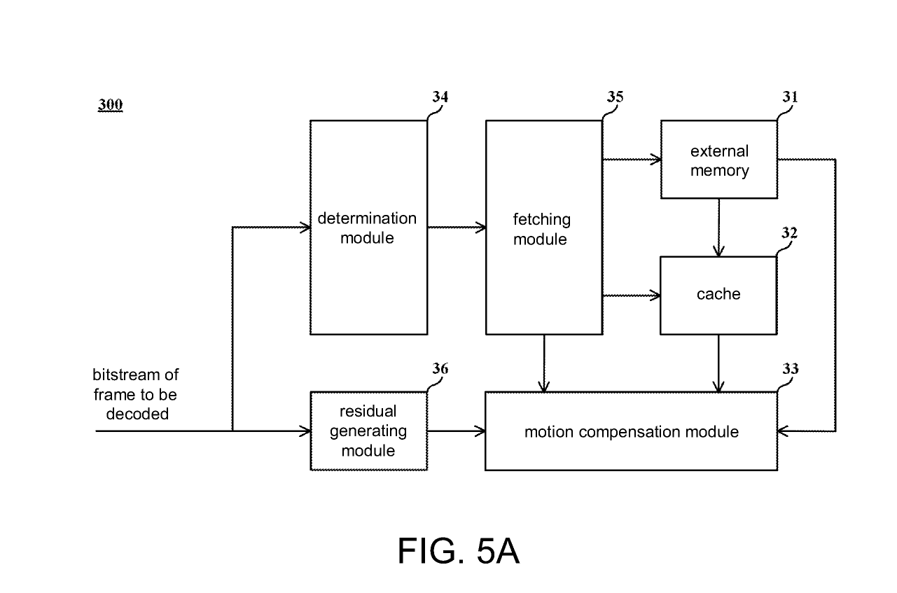

FIG. 3 shows an operating timing diagram of the encoder 200. A time interval T1 specifies the time that the motion compensation module 23 performs motion compensation on encoding the image block B1. A time interval T2 specifies the time that the determination module 24 generates the motion vector of the image block B2. Assume that the motion vector generated by the determination module 24 indicates that the reference region corresponding to the image block B2 is distributed in blocks R1 and R2 in the reference frame. A time interval T3 specifies the response time of the external memory 21 after the fetching module 25 sends out a request for fetching block R1. A time interval T4 specifies the time for transmitting block R1 from the external memory 21 to the cache 22. A time interval T5 specifies the response time of the external memory 21 after the fetching module 25 sends out a request for fetching the block R2. A time interval T6 specifies the time for sending the block R2 from the external memory 21 to the cache 22. Time intervals T7 and T8 specify the time that the motion compensation module 23 accesses the blocks R1 and R2 from the cache 22, respectively. A time interval T9 specifies the time that the motion compensation module 23 performs the motion compensation encoding on the image block B2.

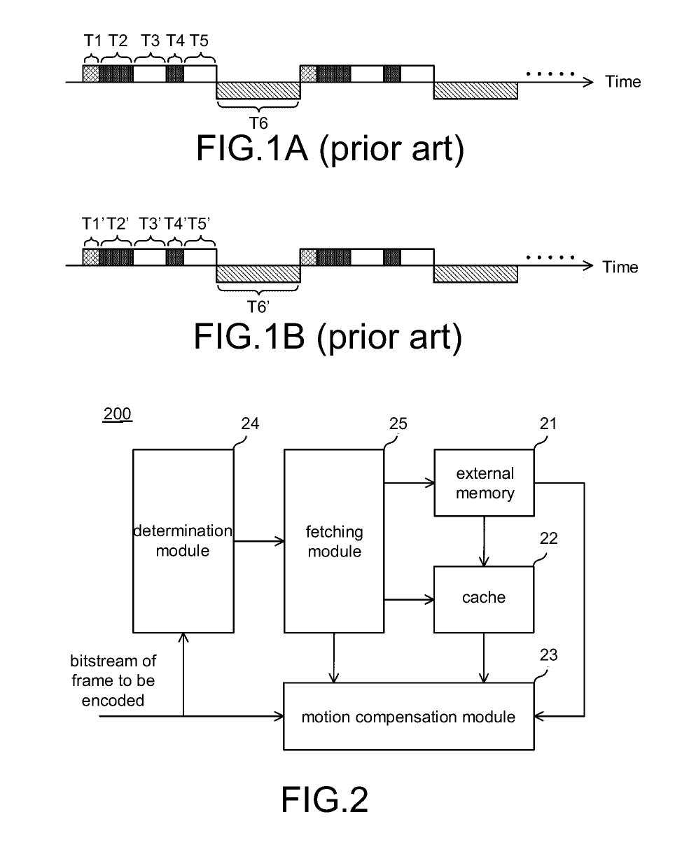

As shown in FIG. 3, the time intervals T2 and T3 completely overlap the time interval T1, and the time interval T4 partially overlaps the time interval T1. Although lengths of the time intervals shown in FIG. 3 are merely examples, compared to conventional situations in FIG. 1A, the image block encoding can be practically completed within a shorter period of time since the encoder 200 brings forward a time point of fetching data from the external memory 21. It should be noted that a starting time of the time interval T2 may also be advanced to be the same as or even earlier than a starting time of the time interval T1.

In practice, the determination module 24 may determine the motion vector of the image block B2 by directly comparing the image block B2 with the reference frame. Alternatively, the determination module 24 may generate a predicted motion vector according to at least one adjacent block and/or at least one adjacent motion vector as the motion vector of the image block B2. For example, assuming that the image blocks B1 and B2 are adjacent to each other, the determination module 24 may derive the motion vector of the image block B2 according to the generated motion vector of the image block B1. Compared to directly comparing the image block with the reference frame, the approach of predicting the motion vector is usually more time saving to further enhance the efficiency of the encoder 200. A result obtained according to a prediction basis based on an adjacent motion vector generally differs from an optimal value by a moderate range under most situations. It should be noted that a reference target of the determination module 24 is not limited to the motion vector of the image block B1, and the motion vector for predicting the image block B2 may also be a weighted average of motion vectors of multiple image blocks. Further, the determination module 24 may also flexibly select data for predicting the motion vector of the image block B2 according to properties (e.g., whether the image block B2 is an object border in an image) of the image block B2.

As previously stated, the difference between the predicted motion vector of the image block B2 and an optimal motion vector is usually within a moderate range. Thus, the motion compensation module 23 may be designed to ignore the difference between the predicted motion vector and the optimal motion vector. That is to say, regardless of the motion vector predicted by the determination module 24, the motion compensation module 23 performs the motion compensation encoding according to the predicted motion vector. In other words, the motion compensation module 23 may adopt the image difference between the image block B2 and the reference region corresponding to the predicted motion vector as the residual of the image block B2, and generates encoded data representing the image block B2 according to the image difference and the motion vector.

In an embodiment, before the motion compensation module 23 performs the motion compensation encoding on the image block B2, the determination module 24 may be designed to further determine an actual motion vector (i.e., the optimal motion vector) of the image block B2 relative to the reference frame, and to compare the predicted motion vector with the actual motion vector. When the difference between the predicted motion vector and the actual motion vector is greater than a predetermined threshold, the fetching module 25 further fetches an actual reference region, corresponding to the actual motion vector, in the reference frame from the external memory for the motion compensation module 23 to the image block B2. In contrast, when the difference between the predicted motion vector and the actual motion vector is smaller than the predetermined threshold, the fetching module 25 does not again fetch data from the external memory 21, and the motion compensation module 23 directly generates the encoded data from the image block B2 according to the reference region, corresponding to the predicted motion vector, which is already fetched to and stored in the cache 22.

It should be noted that the fetching module 25 may control the actual reference region to be directly fetched from the external memory 21 to the motion compensation module 23 without going through the cache 22. In practice, given that the motion vector is generated by the determination module 24, instead of waiting for the actual motion vector to be generated, the fetching module 25 starts fetching the reference region corresponding to the predicted motion vector to the cache 22. In addition, since the possibility of again fetching the actual reference region from the external memory 21 is rather small, the encoding efficiency of the encoder 200 is preferred over the conventional solution even if occasionally re-fetching the actual reference region is required.

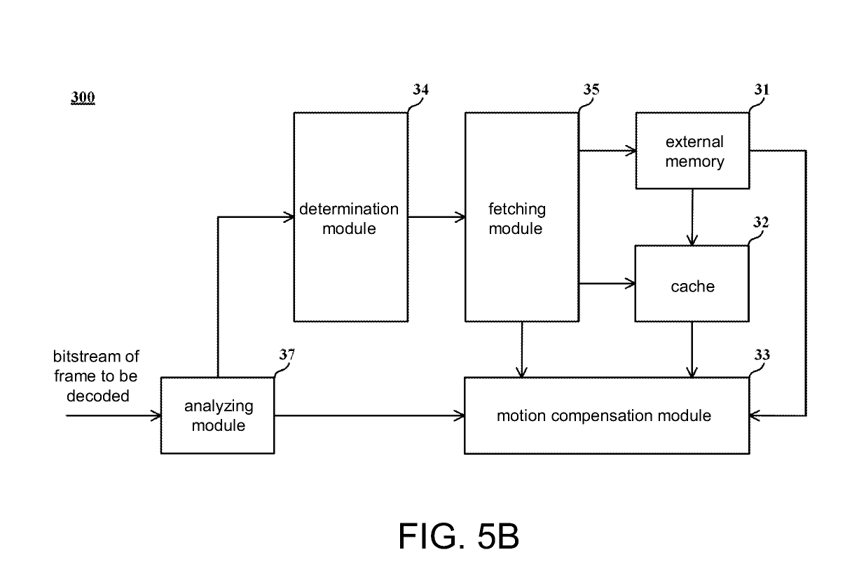

As previously described, adjacent image blocks usually have similar motion vectors. Therefore, the adjacent image blocks may likely correspond to adjacent reference regions. FIG. 4 shows an example of relations between a reference frame and reference regions. In this example, a reference region X1 of an image block B1 is distributed in blocks R1, R2, R4 and R5 in the reference frame, and a reference region X2 of an image block B2 is distributed in blocks R2, R3, R5, and R6 in the reference frame. Taking the external memory 21 implemented by a DRAM for example, limited by access characteristics of a DRAM, instead of fetching only the reference region X1, the fetching module 25 is compelled to fetch the entire blocks R1, R2, R4 and R5 to the cache 22 for the motion compensation module 23 to process the image block B1.

In an embodiment, before fetching a reference region according to the motion vector generated by the determination module 24, the fetching module 25 first determines whether at least a part of the reference region is stored in the cache 22. When the entire reference region is stored in the cache 22, the fetching module 25 does not fetch any data from the external memory 21. When a part of the reference region is stored in the cache 22, the fetching module 25 only fetches a remaining region of the reference region that is not yet stored in the cache 22 from the external memory 21 to the cache 22, and does not re-fetch the data that is already stored in the cache 22. Taking FIG. 4 as an example, to process the image block B1, the blocks R1, R2, R4 and R5 are stored in the cache 22. When the motion vector generated by the determination module 25 indicates that the reference region X2 of the image block B2 is distributed in the blocks R2, R3, R5 and R6 in the reference frame, the fetching module 25 only fetches the blocks R3 and R6 from the external memory 21 for the image block B2 but does not re-fetch the blocks R2 and R5. Such approach, as data already stored in the cache 22 is not repetitively fetched, further reduces the operating time and the data transmission amount of the encoder 200.

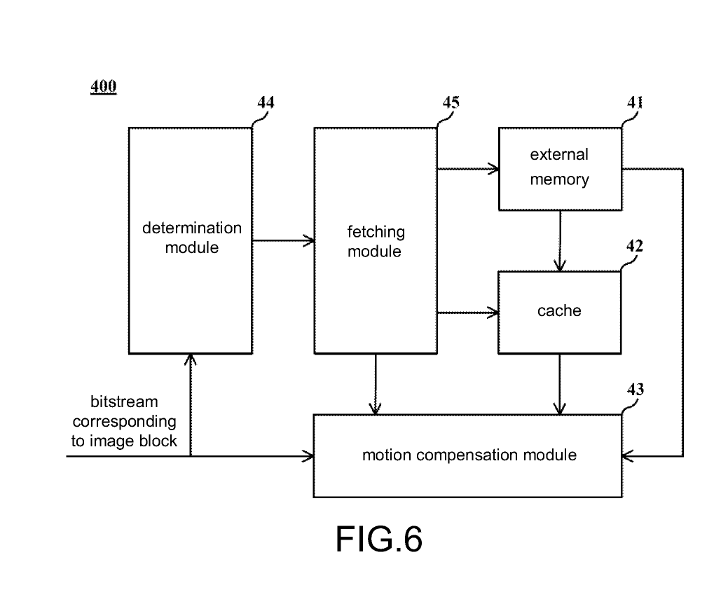

FIG. 5A shows a decoder 300 according to an embodiment of the present invention. The decoder 300 includes an external memory 31, a cache 32, a motion compensation module 33, a determination module 34, a fetching module 35 and a residual generating module 36. In practice, the decoder 300 may be integrated with various image processing systems or image playback apparatuses, or may be an independent unit as explained previously. The external memory 32 stores a reference frame that is to be processed or is being processed by the motion compensation module 33. More specifically, the reference frame is a comparison basis of blocks of a frame to be decoded for generating a motion vector and a residual at an encoder end.

As shown in FIG. 5A, a bitstream of the frame to be decoded is respectively provided to the determination module 34 and the residual generating module 36. The residual generating module 36 analyzes the bitstream to obtain an image difference between an image block and an actual reference region adopted by a corresponding encoder end, that is, to obtain the residual of the image block. Assume that the motion compensation module 33 sequentially performs a motion compensation decoding on two image blocks B1 and B2 in the frame to be decoded to respectively reconstruct the image blocks B1 and B2. When the motion compensation module 33 performs a motion compensation decoding on the image block B1, the determination module 34 determines a motion vector of the image block B2 relative to the reference frame. After the determination module 34 generates the motion vector of the image block B2, according to the motion vector, the fetching module 35 fetches a reference region, corresponding to the motion vector, in the reference frame from the external memory 31 to the cache 32 for the motion compensation block 33 to perform the motion compensation decoding on the image block B2. The motion compensation module 33 is then capable of reconstructing the image block B2 according to the reference region and the image difference obtained by the residual generating module 36.

Similarly, the determination module 34 may generate a predicted motion vector as the motion vector of the image block B2 according to at least one adjacent block and/or at least one adjacent predicted motion vector. The motion compensation module 33 may be designed to ignore the difference between the predicted motion vector and the actual motion vector into consideration. That is to say, regardless of the motion vector predicted by the determination module 24, the motion compensation module 23 performs the motion compensation decoding according to the predicted motion vector. Compared to conventional situations in FIG. 1B, the image block decoding can be practically completed within a shorter period of time since the decoder 300 brings forward a time point of fetching data from the external memory 31.

FIG. 5B shows the decoder 300 according to another embodiment. In this embodiment, the residual generating module 36 is replaced by an analyzing module 37. The analyzing module 37 analyzes the bitstream to obtain the image difference between an image block and an actual reference region adopted by an encoder and the actual motion vector. It should be noted that, before the analyzing module 37 obtains the actual motion vector, the fetching module 35 already begins fetching the reference region to the cache 32. After the analyzing module 37 obtains the actual motion vector, the determination module 34 compares the predicted motion vector with the actual motion vector. When a difference between the predicted motion vector and the actual motion vector is greater than a predetermined threshold, the fetching module 35 further fetches the actual reference region from the external memory for the motion compensation module 33 to process the image block. In contrast, when the difference between the predicted motion vector and the actual motion vector is smaller than the predetermined threshold, the motion compensation module 33 directly adopts the reference region, corresponding to the predicted motion vector, stored in the cache 32 to perform the motion compensation decoding.

In practice, the concept that data is not repetitively fetched may also be applied to the decoder 300 in FIG. 5A or FIG. 5B.

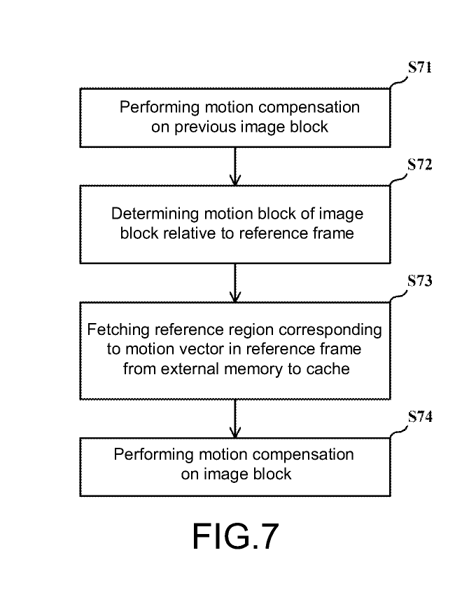

FIG. 6 shows an image processing apparatus 400 according to another embodiment of the present invention. The image processing apparatus 400 includes an external memory 41, a cache 42, a motion compensation module 43, a determination module 44 and a fetching module 45. In practice, the image processing apparatus 400 may be integrated with various image processing systems or image playback apparatuses, or may be an independent unit, as explained previously. The external memory 41 stores a reference frame associated with an image block. The motion compensation module 43 performs motion compensation (e.g., a motion compensation encoding or a motion compensation decoding) on the image block. The determination module 44 determines a motion vector of the image block relative to the reference frame. The fetching module 45 confirms a reference region corresponding to the motion vector in the reference frame, and determines whether at least a part of the reference region is stored in the cache 42.

When none of the reference region is stored in the cache 42, the fetching module 43 fetches the entire reference region from the external memory 41 to the cache 42. When a part of the reference region is stored in the cache 42, the fetching module 45 only fetches a remaining region of the reference region that is not yet stored in the cache 42 from the external memory 41 to the cache 42 for the motion compensation module 43 to process the image block. In contrast, when the entire reference region is stored in the cache 42, the fetching module 45 does not again fetch any data. Thus, by avoiding repetitive data fetching, the image processing apparatus 400 effectively reduces the operating time.

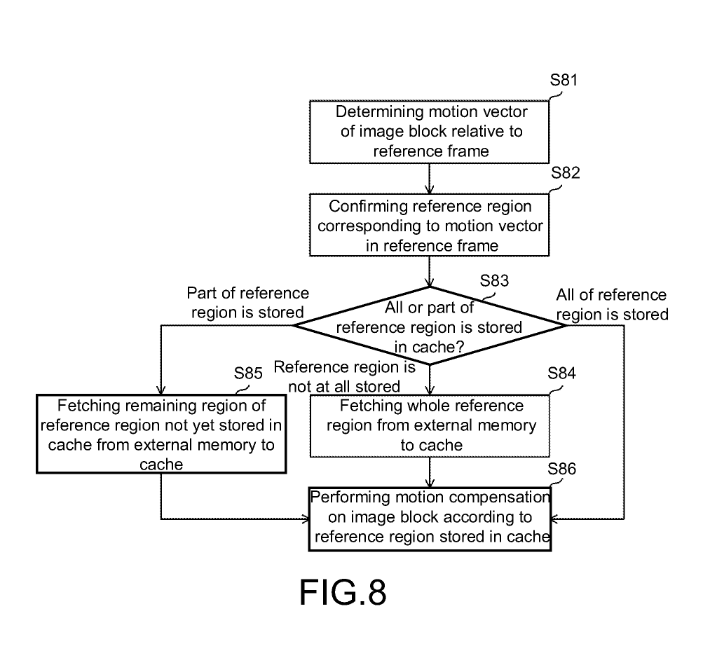

According to yet another embodiment of the present invention, an image processing method cooperating with an external memory and a cache is provided. The external memory stores a reference frame associated with an image block. FIG. 7 shows a flowchart of the method. In Step S71, motion compensation is performed on a previous image block. In Step S72, before Step S71 ends, a motion vector of the image block relative to the reference frame is determined. Step S73 is performed after Step S72 to fetch a reference region, corresponding to the motion vector, in the reference frame from the external memory to the cache. In Step S74, motion compensation is performed on the image block. Operation details and modifications of circuits in the descriptions associated with the encoder 200 and the decoder 300 may also be applied to the image processing method in FIG. 7, and shall be omitted herein.

According to yet another embodiment of the present invention, an image processing method cooperating with an external memory and a cache is provided. The external memory stores a reference frame associated with an image block. FIG. 8 shows a flowchart of the method. In Step S81, a motion vector of the image block relative to the reference frame is determined. In Step S82, a reference region corresponding to the motion vector in the reference frame is confirmed. In Step S83, it is determined whether at least a part of the reference region is stored in the cache. When a determination result of Step S83 indicates that none of the reference region is stored in the cache, Step S84 is performed to fetch the entire reference region from the external memory to the cache. When the determination result of Step S83 indicates that a part of the reference region is stored in the cache, Step S85 is performed to fetch a remaining region of the reference region that is not stored in the cache from the external memory to the cache. When the determination result of Step S83 indicates that the entire reference region is stored in the cache, Step S86 is performed to perform motion compensation on the image block according to the reference region stored in the cache. In Step S86, the motion compensation may be a motion compensation encoding or a motion compensation decoding.

With the above embodiments, a motion compensation image processing apparatus and associated method is provided. While performing motion compensation on an image block, reference data needed for a next image block is in advance fetched from an external memory to a cache to achieve time saving. Moreover, as data stored in the cache is not repetitively fetched, the image processing apparatus and associated method of the present invention further enhances processing efficiency.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A motion compensation image processing apparatus, comprising:
an external memory, for storing a reference frame associated with an image block;
a cache;
a motion compensation module, for sequentially performing motion compensation on a previous image block and the image block;
a determination module, for determining a motion vector of the image block relative to the reference frame when the motion compensation module performs motion compensation on the previous image block; and
a fetching module, for fetching a reference region, corresponding to the motion vector, in the reference frame from the external memory to the cache before the motion compensation module performs motion compensation on the image block.

2. The apparatus according to claim 1, wherein the determination module predicts the motion vector according to type information of an adjacent block adjacent to the image block or an adjacent motion vector.

3. The apparatus according to claim 2, wherein the motion compensation module determines an image difference between the image block and the reference region, and generates encoded data representing the image block according to the image difference and the motion vector.

4. The apparatus according to claim 2, further comprising:
a residual generating module, for analyzing an encoded data corresponding to the image block to obtain an image difference between the image block and an actual reference region;
wherein, the motion compensation module reconstructs the image block according to the reference region and the image difference.

5. The apparatus according to claim 2, wherein the determination module further determines an actual motion vector of the image block relative to the reference frame and compares the motion vector with the actual motion vector before the motion compensation module performs motion compensation on the image block; the fetching module starts fetching the reference region to the cache before the actual motion vector is generated; and when a difference between the motion vector and the actual motion vector is greater than a predetermined threshold, the fetching module fetches an actual reference region corresponding to the actual motion vector from the external memory.

6. The apparatus according to claim 2, further comprising:
an analyzing module, for analyzing encoded data corresponding to the image block to obtain an image difference between the image block and an actual reference region and an actual motion vector;
wherein, the fetching module starts fetching the reference region to the cache before the actual motion vector is generated; and the determination module further compares the predicted motion vector with the actual motion vector, and the fetching module fetches an actual reference region corresponding to the actual motion vector from the external memory when a difference between the motion vector and the actual motion vector is greater than a predetermined threshold.

7. The apparatus according to claim 1, wherein the fetching module fetches a remaining region of the reference region that is not stored in the cache from the external memory to the cache.

8. A motion compensation image processing method cooperating with an external memory and a cache, the external memory storing a reference frame associated with an image block, the image processing method comprising:
a) performing motion compensation on a previous image block;
b) before step (a) ends, determining a motion vector of the image block relative to the reference frame;
c) fetching a reference region, corresponding to the motion vector, in the reference frame from the external memory to the cache; and
d) performing motion compensation on the image block.

9. The method according to claim 8, wherein step (b) comprises predicting the motion vector according to type information of an adjacent block adjacent to the image block or an adjacent motion vector.

10. The method according to claim 9, wherein step (d) comprises:
determining an image difference between the image block and the reference region; and
generating encoded data representing the image block according to the image difference and the motion vector.

11. The method according to claim 9, before step (d), further comprising:
analyzing encoded data corresponding to the image block to obtain an image difference between the image block and an actual reference region;
wherein, step (d) reconstructs the image block according to the reference region and the image difference.

12. The method according to claim 9, before step (d), further comprising:
determining an actual motion vector of the image block relative to the reference frame;
comparing the motion vector with the actual motion vector; and
fetching an actual reference region corresponding to the actual motion vector from the external memory when a difference between the motion vector and the actual motion vector is greater than a predetermined threshold;
wherein, step (c) is performed before the actual motion vector is generated.

13. The method according to claim 9, before step (d), further comprising:
analyzing encoded data corresponding to the image block to obtain an image difference between the image block and an actual reference region and an actual motion vector;
comparing the predicted motion vector and the actual motion vector to generate a comparison result;
fetching an actual reference region corresponding to the actual motion vector from the external memory when the comparison result is greater than a predetermined threshold;
wherein, step (c) is performed before the actual motion vector is obtained.

14. The method according to claim 8, wherein step (c) comprises:
fetching a remaining region of the reference region that is not stored in the cache from the external memory to the cache.

15. A motion compensation image processing apparatus, comprising:
an external memory, for storing a reference frame associated with an image block;
a cache;
a motion compensation module, for performing motion compensation on the image block;
a determination module, for determining a motion vector of the image block relative to the reference frame; and
a fetching module, for fetching a remaining region of a reference region corresponding to the motion vector that is not stored in the cache from the external memory to the cache.

16. The apparatus according to claim 15, wherein the motion compensation module performs a motion compensation encoding or a motion compensation decoding.

17. A motion compensation image processing method cooperating with an external memory and a cache, the external memory storing a reference frame associated with an image block, the image processing method comprising:
determining a motion vector of the image block relative to the reference frame;
fetching a remaining region of a reference region corresponding to the motion vector that is not stored in the cache from the external memory to the cache; and
performing motion compensation on the image block according to the reference region stored in the cache.

18. The method according to claim 17, wherein the motion compensation is a motion compensation encoding or a motion compensation decoding.
